(19) United States
(12) Patent Application Publication
(10) Pub. No.: US 2009/0086096 A1
(43) Pub. Date: Apr. 2, 2009

(54) Raw Mode for Vertical Blanking Interval (VBI) Data

(76) Inventors: Amit Kumar Singh, Indianapolis, IN (US); Thomas Edward Horlander, Indianapolis, IN (US); Matthew John Wahoske, Fishers, IN (US)

Correspondence Address: Robert D. Shedd;Thomson Licensing LLC, PO Box 5312, PRINCETON, NJ, 08543-5312, US

(21) Appl. No.: 12/085,889

(22) PCT Filed: Oct. 12, 2006
(86) PCT No.: PCT/US06/39902

§ 371 Date: Jun. 2, 2008

Related U.S. Application Data
(60) Provisional application No. 60/756,390, filed on Jan. 5, 2006.

(51) Int. Cl. H04N 7/088

(52) U.S. Cl. 348/478; 348/E07.03

(57) ABSTRACT

A vertical blanking interval (VBI) encoder for providing VBI encoded data supports a “RAW mode” of operation. In particular, the VBI encoder comprises a first FIFO (first-in, first-out) buffer for providing service data to be VBI encoded, and a second FIFO for specifying VBI format data.

### BACKGROUND OF THE INVENTION

The present invention generally relates to communications systems and, more particularly, to television (TV) systems, e.g., TVs, set-top boxes (cable, satellite), etc.

As known in the art, television systems may transmit additional (or service) data during the vertical blanking interval (VBI). The VBI extends over 40 horizontal lines. Typically, a VBI encoder is used to encode any service data on a designated line in accordance with a particular format (or standard) such as wide screen signaling (WSS), world system teletext (WST), closed caption, etc.

Turning now to FIG. 1, a prior art VBI encoder is shown. VBI encoder 150 includes one, or more, register(s) 115, a memory 130 (e.g., a first-in, first-out (FIFO) 130) for storing service data to be VBI encoded (also referred to herein as VBI data) and a VBI modulator 140 for providing VBI encoded data 141. As known in the art, VBI modulator 140 includes a number of hard-coded predefined VBI formats 120, e.g., wide screen signaling (WSS), world system teletext (WST), closed caption, etc. In this regard, the particular VBI format used for a particular line by VBI encoder 150 is determined as a result of one, or more, register values 116 provided by register(s) 115. The values of register 115 are controlled by processor 105, via data/control bus 101. In particular, processor 105 selects the particular VBI format to use for a particular line via register(s) 115 and also provides service data to VBI data FIFO 130 via data/control bus 101. The service data includes the data to be modulated, the run-in and the start code. It should be observed from FIG. 1 that processor 105 fills up FIFO 130 with service data for particular lines of the VBI. VBI modulator 140 of VBI encoder 150 is responsive to register values 116 and selects for each line of the VBI one of the hard-coded VBI formats 120. The selected VBI format is defined by particular values representing where on the line the VBI data starts and ends, the amplitude of the VBI encoded signal, the modulation frequency and the length. As a result, VBI modulator 140 encodes the service data stored in VBI data FIFO 131 (retrieved via signal 131) and provides VBI encoded data signal 141 for a particular line. It should be noted that for simplicity, control signaling to VBI data FIFO 130 is not shown in FIG. 1. VBI encoded data signal 141 is combined with a video signal 154, via combiner 155, to provide an output video signal 156, which includes the VBI encoded data signal. Video signal 154 and output video signal 156 represents luminance signals, as known in the art.

### SUMMARY OF THE INVENTION

As described above, a VBI encoder is designed to encode service data for a horizontal line of the VBI in accordance with one of a number of predefined VBI formats. In this regard, we have observed that existing VBI encoders are restricted to these predefined formats. Unfortunately, if a VBI format changes or a new VBI format is subsequently introduced, an existing VBI encoder may be rendered useless. Therefore, and in accordance with the principles of the invention, a VBI encoder provides VBI encoded data in accordance with VBI format data provided by a processor. Thus, should a VBI format change or a new VBI format be introduced, the VBI encoder is not rendered useless.

In an illustrative embodiment of the invention, a VBI encoder comprises a first FIFO (first-in, first-out) buffer for providing service data to be VBI encoded, and a second FIFO for specifying VBI format data. The ability to alter the data in the first FIFO and the second FIFO makes it possible to insert service data for any current standard of VBI data—or future standard of VBI data—into a line of the VBI. As described herein, a VBI encoder in accordance with the principles of the invention supports a “RAW mode” of operation.

In view of the above, and as will be apparent from reading the detailed description, other embodiments and features are also possible and fall within the principles of the invention.

### BRIEF DESCRIPTION OF THE DRAWINGS

FIG. 1 shows a prior art VBI encoder;

FIG. 2 shows an illustrative receiver in accordance with the principles of the invention;

FIG. 3 shows an illustrative VBI encoder in accordance with the principles of the invention;

FIG. 4 shows an illustrative VBI control FIFO in accordance with the principles of the invention;

FIG. 5 shows an illustrative format for a VBI control word in accordance with the principle of the invention;

FIG. 6 shows an illustrative flow chart in accordance with the principles of the invention;

FIG. 7 shows another illustrative VBI control FIFO in accordance with the principles of the invention;

FIG. 8 shows an illustrative embodiment of a VBI control word format in accordance with the principles of the invention; and

FIG. 9 shows an illustrative frequency generator for use in the VBI encoder of FIG. 3.

### DETAILED DESCRIPTION

Other than the inventive concept, the elements shown in the figures are well known and will not be described in detail. Also, familiarity with television broadcasting and receivers is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire), ATSC (Advanced Television Systems Committee) (ATSC) and VBI encoding is assumed. Likewise, other than the inventive concept, transmission concepts such as eight-level vestigial sideband (8-VSB), Quadrature Amplitude Modulation (QAM), and receiver components such as a radio-frequency (RF) front-end, or receiver section, such as a low noise block, tuners, and demodulators is assumed. Similarly, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

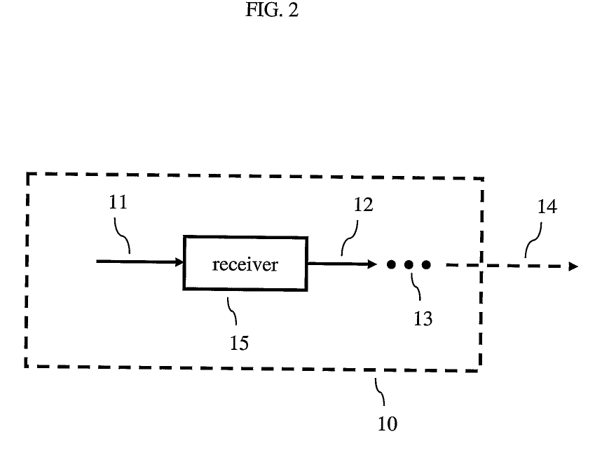

A high-level block diagram of an illustrative device 10 in accordance with the principles of the invention is shown in FIG. 2. Device 10 includes a receiver 15. As described below, receiver 15 functions in accordance with the principles of the invention for receiving service data 11 and for providing an output video signal 12, which includes a VBI encoded signal formatted in accordance with one of a number of VBI formats, at least one of which is a “RAW mode”. Illustratively, device 10 may be a set-top box (cable, satellite, etc.), TV set, personal computer, mobile phone (e.g., with video output), etc. In this regard, the video output signal 12 may be further processed by device 10 (as represented by the ellipses 13) before being transmitted to another device, or provided to a display, as represented by dashed arrow 14. For example, in the context of a set-top box, dashed arrow 14 may represent a re-modulated video signal (e.g., at a frequency corresponding to channel 4); or, dashed arrow 14 may represent a base band video signal before application to a display element (e.g., a flat-panel, cathode-ray-tube (CRT), etc.).

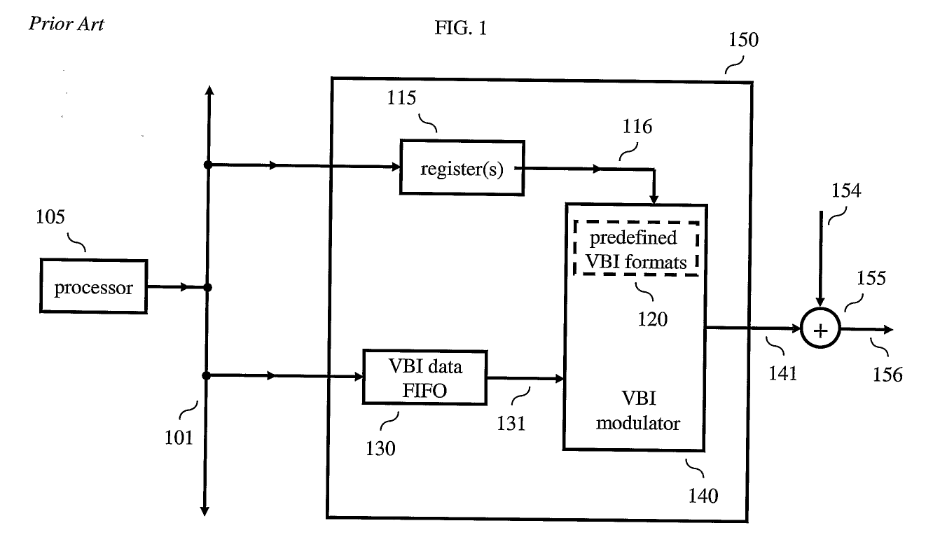

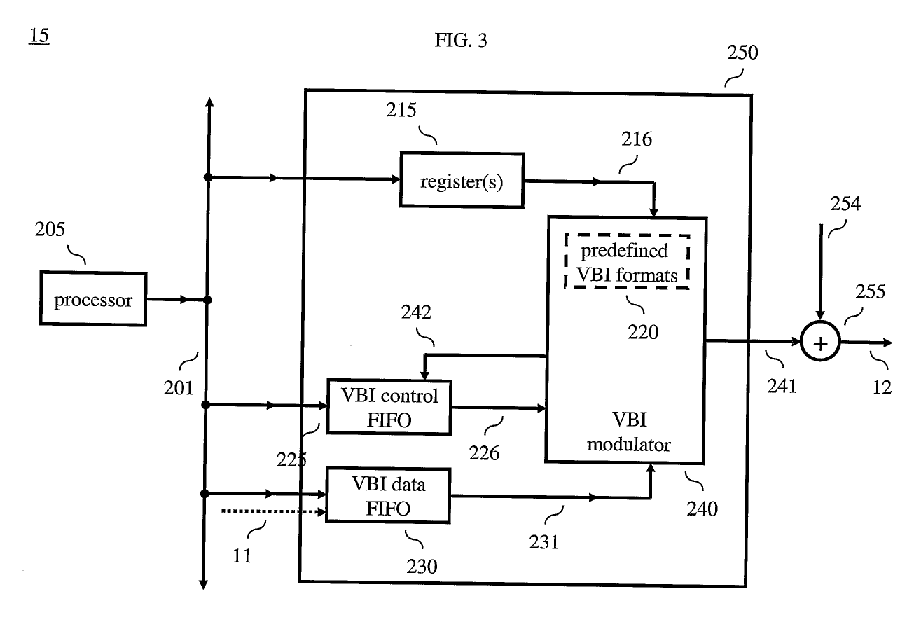

Turning now to FIG. 3, an illustrative block diagram of a portion of receiver 15 relevant to the inventive concept is shown. Receiver 15 is a processor-based system and includes one, or more, processors and associated memory (not shown) as represented by processor 205. In this context, the associated memory is used to store computer programs, or software, which is executed by processor 205, and to store data. Processor 205 is representative of one, or more, stored-program control processors and these do not have to be dedicated to the VBI function, e.g., processor 205 may also control other functions of device 10. Receiver 15 also includes VBI encoder 250 and combiner 255. Other than the inventive concept, VBI encoder 250 functions in a fashion similar to that described above with respect to VBI encoder 150 of FIG. 1. VBI encoder 250 includes one, or more, register(s) 215, a memory 225 (e.g., a first-in, first-out (FIFO) 225) for storing VBI control data (VBI format data) for formatting lines in the VBI, a memory 230 (e.g., a first-in, first-out (FIFO) 230) for storing service data to be VBI encoded and a VBI modulator 240 for providing VBI encoded data 241. VBI modulator 240 includes a number of hard-coded predefined VBI formats 220, e.g., wide screen signaling (WSS), world system teletext (WST), closed caption, etc.

In accordance with the principles of the invention, VBI encoder 250 supports a “RAW mode” of operation and a “predefined mode” of operation. In the predefined mode of operation, VBI encoder 250 formats service data in accordance with one of the hard-coded predefined VBI formats 220, which is not writeable by processor 205. Each hard-coded predefined VBI format 220 includes data representing where on the line the VBI data starts and ends, the amplitude of the VBI encoded signal, the modulation frequency and the length. However, in the RAW mode of operation, VBI encoder 250 formats service data in accordance with the VBI formats stored in memory FIFO 225, which are provided by processor 205. In this regard, the particular mode and VBI format used for a particular line by VBI encoder 250 is determined as a result of one, or more, register values 216 provided by register(s) 215. The values of register 215 are controlled by processor 205, via data/control bus 201. In particular, processor 205 selects the particular VBI format (and mode) to use for a particular line via register(s) 215 and also provides service data to VBI data FIFO 230 via data/control bus 201. In addition, when processor 205 selects a RAW mode of operation, processor 205 also provides particular VBI formats to VBI control FIFO 225. As such, it should be observed from FIG. 3 that, in the RAW mode of operation, processor 205 not only fills up FIFO 230 with service data for particular lines of the VBI, but also fills up FIFO 225 with the corresponding VBI format data to be used for each line. In this regard, it should be noted that even though a VBI format may be a standard, that format may still be provided by processor 205 to VBI encoder 240 via VBI control FIFO 225. Indeed, a VBI encoder in accordance with the principles of the inventions does not even have to use two sources of VBI formats as represented by hard-coded predefined VBI formats 220 and memory 225, e.g., memory 225 may just be used. It should also be noted that for simplicity, control signaling to VBI data FIFO 230 is not shown in FIG. 3.

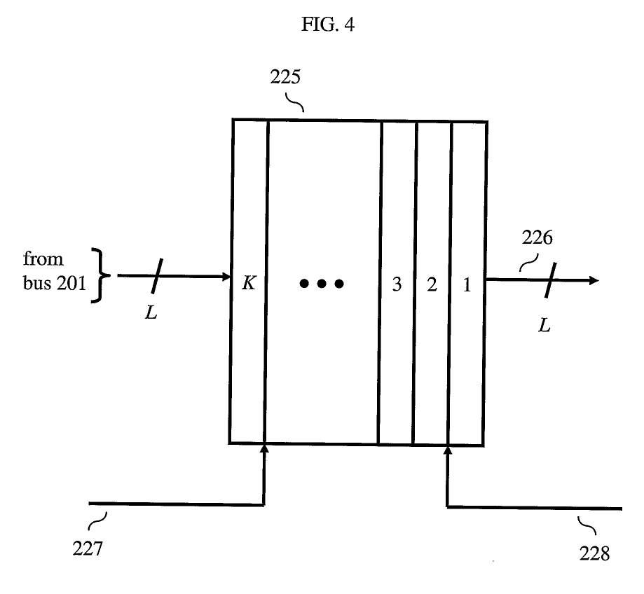

Turning now to FIG. 4, FIFO 225 is shown in more detail. As noted above, the data in this memory is maintained by processor 205 via data/control bus 201. Illustratively, FIFO 225 stores K data elements, each data element comprising L bits (e.g., FIFO 225 is K deep by L bits wide). For storing data in FIFO 225, processor 205 writes data to FIFO 225 as a function of the CPU (central processing unit) clock 227 associated with processor 205. For retrieving data from FIFO 225, VBI modulator 240 reads data as a function of pixel clock 228, which as known in the art is related to video signal 254. For simplicity, other control signals such as address, read and write signals are not shown in FIG. 4. A read pointer (not shown) is reset to start fresh on each new video frame. A write pointer (not shown) is reset on each vertical synchronization (vsync). Hence, any new write to FIFO 225 for the next video frame should be done after all the VBI lines have been displayed.

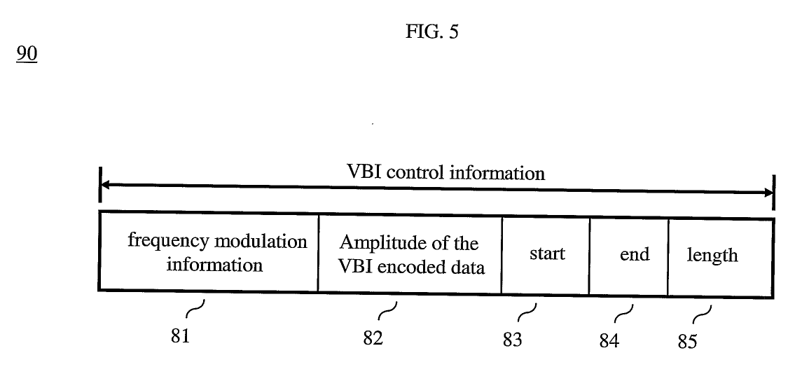

The data stored in FIFO 225 includes VBI control words. Referring now to FIG. 5, an illustrative format 90 for a VBI control word is shown. A VBI control word provides information about where on the line the VBI data starts (83) and ends (84), the amplitude of the VBI encoded signal (82), the modulation frequency (81) and the length (85). It should be noted that this format information is merely illustrative and additional, or less, information may be provided in a VBI control word.

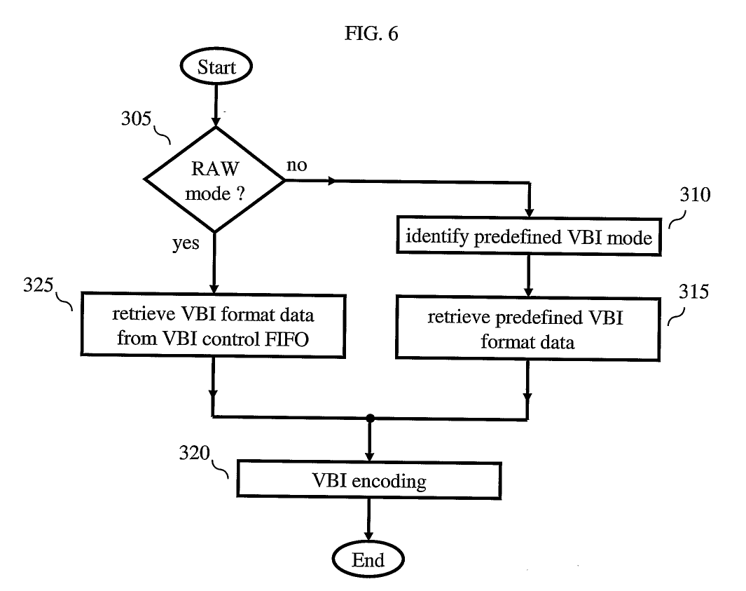

Turning now to FIG. 6, an illustrative flow chart for use in performing VBI encoding in accordance with the principles of the invention is shown. It is assumed that processor 205 has already stored service data in VBI data FIFO 230 for one, or more, VBI lines and, via register(s) 215, specified the VBI mode and/or VBI formats for each of these lines. In step 305, VBI modulator 240 of FIG. 3 determines the operating mode from registers values 216 for a particular VBI line. If processor 205 has selected, via register(s) 215, one of the hard-coded VBI predefined formats 220, then VBI modulator 240 determines that the “predefined mode” has been selected in step 305 and proceeds to step 310. In step 310, VBI modulator 240 identifies the selected predefined format for this VBI line from the information in register(s) 215. In step 315, VBI modulator 240 uses the selected hard-coded predefined VBI format 220. In step 320, VBI modulator 240 reads the VBI data from VBI data FIFO 230 (provided via signal 231) and provides VBI encoded data signal 241 formatted in accordance with the retrieved predefined format of step 315. Turning briefly back to FIG. 3, the VBI encoded data signal 241 is combined with a video signal 254, via combiner 255, to provide an output video signal 12, which includes the VBI encoded data signal. Video signal 254 and output video signal 12 represents luminance signals, as known in the art.

On the other hand, if, in step 305, processor 205 has selected, via register(s) 215, the “RAW mode” of operation for a particular VBI line, then VBI modulator 240 determines that the “RAW mode” has been selected in step 305 and proceeds to step 325. In step 325, VBI modulator 240 retrieves, via signal 242, the associated VBI format data, via signal 226, written by processor 205 to memory 225 for that VBI line. In step 320, VBI modulator 240 reads the VBI data from VBI data FIFO 230 (provided via signal 231) and provides VBI encoded data signal 241 formatted in accordance with the retrieved VBI format data of step 325 (and shown in FIG. 5). As before, the VBI encoded data signal 241 is combined with a video signal 254, via combiner 255, to provide an output video signal 12, which includes the VBI encoded data signal.

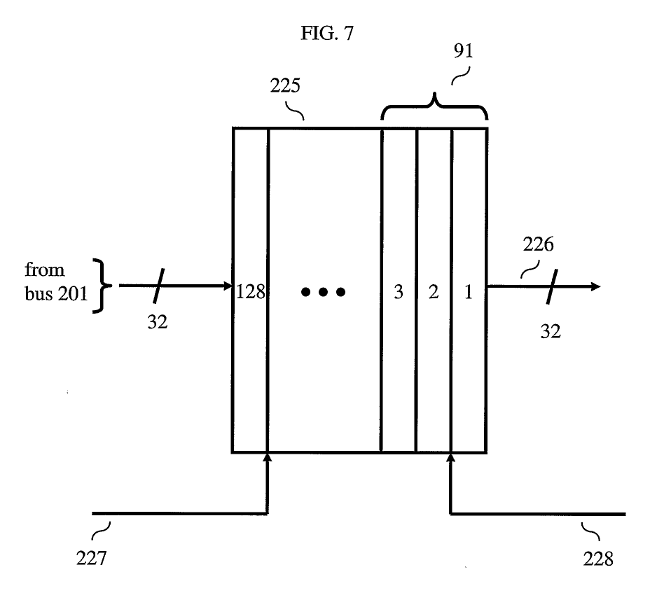

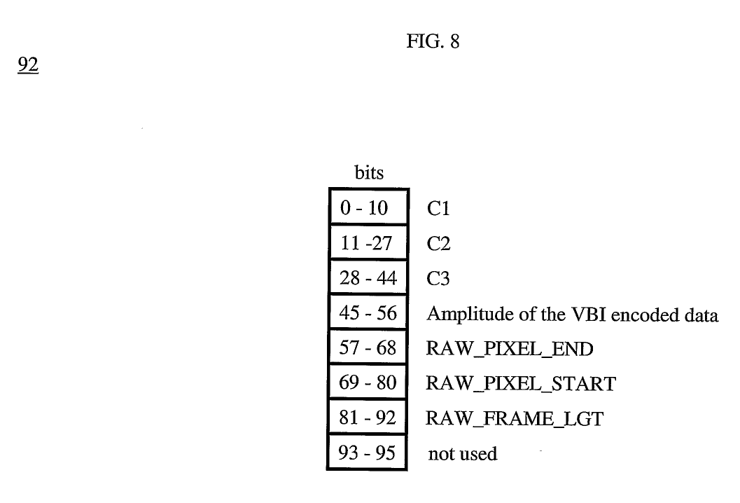

It should be noted that other variations of the inventive concept are possible. For example, the length of a VBI control word can be defined as any number of bits. This is illustrated in FIGS. 7 and 8. In this example, a VBI control word comprises 96 bits and FIFO 225 stores 128 data elements, each data element comprising 32 bits (e.g., FIFO 225 is 128 deep by 32 bits wide). An illustrative VBI control word 91 is shown in FIG. 7 occupying the first three (32 bit wide) locations of FIFO 225. As such, processor 205 performs three write operations to FIFO 225 to provide a VBI control word for each VBI line and VBI modulator 240 performs three read operations to retrieve a VBI control word for each VBI line The first three entries of FIFO 225 are for first VBI line, the next three entries for next VBI line, and so on.

An illustrative format, 92, for VBI control word 91 is shown in FIG. 8. In addition, in this example, the frequency modulation information 81 of FIG. 5 is represented by three timing parameters. In particular, the first 45 bits of data of the VBI control word are used to specify values for timing registers within video modulator 240 for generating VBI encoded data of the appropriate modulation frequency. The number of timing parameters required is a function of the particular VBI modulator. In this example, these 45 bits are divided into three timing parameters C1, C2 and C3. However, the invention is not so limited and more, or fewer, timing parameters can be specified for use by the video encoder. The first 11 bits (bits 0 to 10) correspond to C1, the next 17 bits (bits 11 to 27) correspond to C2 and the last 17 bits (bits 28 to 44) correspond to C3. Continuing with the remainder of format 92, the next 12 bits of data (bits 45 to 56) specify the amplitude of the VBI encoded data. The following 12 bits of data (bits 57 to 68) define the ending position of the VBI data on the VBI line, referred to herein as RAW_PIXEL_END. The next 12 bits of data (bits 69 to 80) define the starting position of the VBI data on the VBI line, referred to herein as RAW_PIXEL_START. The following 12 bits of data (bits 81 to 92) define the total number of bits that need to be put out on the VBI line, including the run-in and start code, referred to herein as RAW_FRAME_LGT. Finally, the last 3 bits of data (bits 93 to 95) are not used.

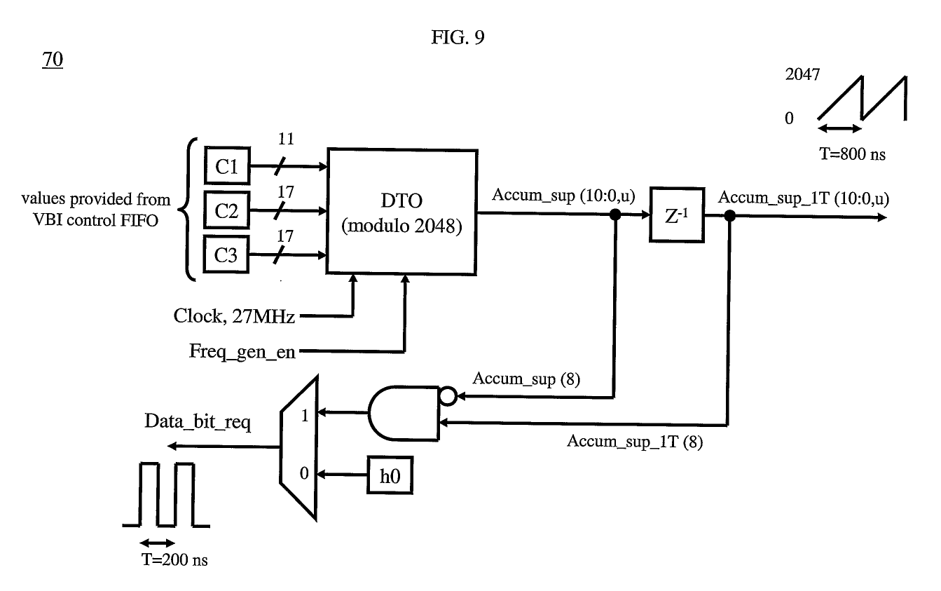

As noted above, the first 45 bits (bits 0 to 44) of data are used to provide timing parameters for use by VBI encoder 240 for determining the modulation frequency for the VBI encoded data. Illustratively, VBI encoder 240 uses a frequency generator 70 as illustrated in FIG. 9. Other than the inventive concept, the components of frequency generator 70 are known in the art, e.g., the DTO (discrete time oscillator) component, etc. As illustrated in FIG. 9, and in accordance with the principles of the invention, particular values for the three timing parameters C1, C2 and C3 are also now provided from VBI control FIFO 225. When frequency generator 90 is enabled (by the signal Freq_gen_en), frequency generator 90 generates a signal at the frequency required by the service on the current video line. As can be observed from FIG. 9, a DTO is used to generate the signal. The DTO comprises an upper and lower stage P:Q counter (2 programmable accumulators modulo 2048 and modulo 33750) (these are not shown in FIG. 9) controlled by the registers C1, C2 and C3. As noted above, these registers also get their values from the VBI control FIFO 225. Processor 205 determines particular values for C1, C2 and C3 depending on particular requirements of the VBI format in accordance with the following equations.

$$\begin{matrix}\frac{Required\_Freq}{Working\_Freq} = \frac{C 1 + \frac{C 2}{33750}}{2048} ; \\ and & ( 1 ) \\ C 3 = 65536 - 33750 + C 2 & ( 2 )\end{matrix}$$

Where the Required_Freq parameter is the frequency of a given VBI data for a given line. This frequency changes based on the type of VBI data. For example, the frequency for close-caption data may be different from the frequency for WST data. The Working_Freq parameter is the frequency for outgoing video data, e.g., 27 MHz (millions of hertz).

An illustrative example for a WSS teletext standard is now described. In this case, the WSS teletext standard requires that:

$$Required\_Freq = \frac{5.0 MHz}{4} .$$

As a result, equation (1) becomes:

$$\frac{1.25}{27} = \frac{C 1 + \frac{C 2}{33750}}{2048} .$$

This equation can alternatively be written as:

$$\frac{1.25}{27} = \frac{x}{2048} \\ where \\ x = C 1 + \frac{C 2}{33750} \qquad ( 3 )$$

Solving equation (3) for x, yields:

$$x = 94.81481 = C 1 + \frac{C 2}{33750} . \qquad ( 4 )$$

Equation (4) can be rewritten as:

$$x = 94.81481 = 94 + 0.81481 = C 1 + \frac{C 2}{33750} . \qquad ( 5 )$$

In other words:
C1=94; and
C2=0.81481(33750)=27500
   Once C2 is determined, then C3 is determined from equation (2) and C3=59286. These values are then loaded by processor 205 into VBI control FIFO 225 for generating VBI encoded data in accordance with a WSS teletext format using a frequency generator as illustrated in FIG. 9.

As described above, a VBI encoder with RAW mode supports any VBI format. Indeed, VBI formats can be changed on-the-fly, e.g., in real-time. In view of the above, the inventive concept is applicable to any system that utilizes the VBI such as, but not limited to, closed caption, wide screen signaling (WSS), world system teletext (WST), Video Program System (VPS), Programming Delivery Control (PDC), Digital Encoder, North American Basic Teletext Specification (NABTS), DVITC, Transparent mode, Copy Generation Management System (CGMS), etc. It should be noted that although the inventive concept was illustrated in the context of a 128 deep by 32 bit wide FIFO, the inventive concept is not so limited and applies to memories of any size. Likewise, although the inventive concept was illustrated in the context of two FIFOs, the inventive concept is not so limited and different types, or combinations, of memories may be used and even a single memory may be used.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of the steps shown in, e.g., FIG. 6, etc. It is therefore to be understood that numerous modifications may be made to the illustrative embodiments and that other arrangements may be devised without departing from the spirit and scope of the present invention as defined by the appended claims.

1. Apparatus for use providing in vertical blanking interval (VBI) encoded data, the apparatus comprising:
a processor; and
a VBI encoder for providing VBI encoded data in accordance with VBI format data provided by the processor.

2. The apparatus of claim 1, wherein the VBI format data comprises at least an amplitude of the VBI encoded data and a VBI frequency.

3. The apparatus of claim 2, wherein the VBI format data further comprises start, end and length data.

4. The apparatus of claim 1, further comprising:
a memory for providing the VBI format data;
wherein the memory is writeable by the processor.

5. The apparatus of claim 4, wherein the memory is L bits wide and the VBI format data is greater than the L bits.

6. The apparatus of claim 4, wherein the memory is a part of the VBI encoder.

7. The apparatus of claim 4, wherein the VBI encoder further comprises:
at least one register for specifying a mode of operation, wherein one mode of operation specifies that the VBI encoder provide VBI encoded data in accordance with VBI formats stored in the memory.

8. The apparatus of claim 4, where in the memory comprises:
a first FIFO (first-in, first-out) buffer for providing data for VBI encoding; and
a second FIFO for providing the VBI format data.

9. The apparatus of claim 1, wherein the VBI encoder further includes a number of hard-coded predefined VBI modes of operation.

10. The apparatus of claim 1, further comprising:
circuitry for combining the VBI encoded data with a video signal to provide an output video signal.

11. A method for use providing in vertical blanking interval (VBI) encoded data, the method comprising:
determining a mode of operation;
selecting between two sources of VBI format data as a function of the determined mode of operation, where one source of VBI format data is a writeable memory and another source of VBI format data is non-writeable;
retrieving VBI format data from the selected source; and
encoding data in accordance with the retrieved VBI format data for providing VBI encoded data.

12. The method of claim 11, wherein the VBI format data comprises at least an amplitude for the VBI encoded data and a VBI frequency.

13. The method of claim 12, wherein the VBI format data further comprises start, end and length data.

14. The method of claim 11, wherein the writeable memory is a first-in, first-out (FIFO) buffer.

15. The method of claim 11, wherein the determining step further comprises:
reading data from at least one register for specifying the mode of operation.

16. The method of claim 11, further comprising:
combining the VBI encoded data with a video signal to provide an output video signal.
